(19) United States
(12) Patent Application Publication
(10) Pub. No.: US 2003/0160693 A1
(43) Pub. Date: Aug. 28, 2003

(54) Status monitoring system employing a movement history and a self-organizing network

(75) Inventor: Atsushi Hisano, San Jose, CA (US)

Correspondence Address: FOLEY AND LARDNER, SUITE 500, 3000 K STREET NW, WASHINGTON, DC, 20007, US

(73) Assignee: OMRON CORPORATION

(21) Appl. No.: 10/080,927

(22) Filed: Feb. 25, 2002

(51) Int. Cl. G08B 1/08

(52) U.S. Cl. 340/539.13

(57) ABSTRACT

The objective of the present invention is to detect, using a universal method, any “movement” in the object being monitored while maintaining security of a container. In this surveillance system according to this invention, the communication relay system is used for sensing the movement of the object to be monitored, not for the communication purpose as the prior art. To wit, the object being monitored has nodes (communication nodes) that have communication functions (low-power transmitters), which are attached at various places in the space where the object to be monitored is located. The communication graph matrix which represents which node can or can not communicate with which nodes. This matrix has a same kink of ID function as a finger print for the human, and it can tell whether the container has been kept safety during the transportation.

### FIELD OF TECHNOLOGY

The present invention relates to a status monitoring system, such as a detection system, surveillance system, identification system, employing a movement history and a self-organizing network. The status monitoring system detects abnormalities or the status of an object under surveillance, such as the objects loaded in freight containers to be monitored. The information devices are, for example, such as identification device for identifying the object, a sensor device to detect any changes on the same, and a memory device to ensure not to be altered unwillingly.

### BACKGROUND OF THE INVENTION

Due to the frequency of terrorist acts internationally, risk management for freight containers being transported on trucks, aircraft, ships, and freight trains has become more important. The possibility exists at a number of places where bombs, poison gas, chemical weapons, radioactive materials or terrorists themselves could be secretly hidden in such freight containers. Further, a wide variety of products or raw materials can be placed in freight containers. Although it is possible in some cases to detect with the conventional sensors any dangerous materials or the like that have been placed inside of these containers, it is probably the case that such detection is difficult in most cases. Yet another possibility, which does not involve adding dangerous materials to a legitimate container, is to load dangerous materials into a similar, bogus container and then swap containers at some point.

Japanese Patent Publication Hei 11-240609 discloses a container surveillance device for use with ground transported containers on trucks wherein a wireless transmitter sends a code disclosing the contents of the container along with the container's own location to the transport destination. Additionally, Japanese Patent Publication Hei 11-345374 uses a position confirmation device to confirm the position during transport, and that transport position information is transmitted to an information center. Then, only after the transport vehicle reaches its destination, the information center issues a password or other ID which is recorded in a lock control unit, and which can then only be opened by inputting the ID. Japanese Patent Publication Hei 9-120410 relates to an autonomous electronic sensor located in close proximity to the cargo being transported, which, by means of a transceiver, communicates with a goods tracking device that is attached to the product container. This goods tracking device also has the ability, when commanded, to transmit the sensing data to a central office on a predetermined schedule.

However, even though the foregoing Japanese Patent Publication Hei 11-240609 makes it possible for the destination of the container to obtain minute-by-minute information about the container's movement, it makes no provision for detecting the opening and closing of the container's doors or for controlling the opening and closing of those doors. On the other hand, Japanese Patent Publication Hei 11-345374 does provide control over the opening and closing of the container doors, but only by requiring the correct input of a password. However, if the password for the opening and closing of the doors is stolen, there is nothing that can be done to detect or prevent an unauthorized person from opening and closing the doors. Japanese Patent Publication Hei 9-120410 reports the cargo sensing data for the container to a central office to enable that office to know the status of the cargo. However, should the container be at a place where reporting is impossible (e.g. if the container is located outside the service area of a base station, or when the antenna for the wireless transmitter is shielded by metal), during that interval, it is not possible to notify the central office of the opening and closing of the container doors or any movement in the container's status.

### SUMMARY OF THE INVENTION

The first objective of the present invention is to detect, using a universal method, any “movement” in the object being monitored while maintaining security, which is not dependent on what kind of sensors are used.

The second objective is to provide the capability of detecting the substitution of the object being monitored, such as the swapping object.

The present invention is applicable to a wide variety of objects of surveillance, automobiles, containers, homes, factory machinery, etc for the surveillance purpose. Among them, the resolution of the problems of the prior art now will be described mainly with reference to cargo containers. The detection of dangerous materials is likely to be affected by such factors as how the cargo is loaded, the type of material of the dangerous article, and its packaging. Thus, rather than designing a conventional sensor appropriately to detect dangerous materials according to the properties of such dangerous materials, the method for detecting the “movement” which would occur during the act of secretly hiding dangerous materials in the container would be a universal detection method for detecting abnormalities that is unaffected by the nature of the dangerous material being detected. Considering that detecting the “movement” of containers having various structures and made from various materials, rather than detecting the dangerous material itself, the greater universality would be achieved by attaching a communication network having one or more communication nodes in the container which communicates each other, to thereby detect “movement between the communication nodes” is a method that is unlikely to be influenced by the materials or structure of the container.

There is also a possibility that rather than dangerous material being secretly hidden in a container, that a bogus container holding dangerous material could be switched with the original container. In order to handle this type of container swapping, it would be necessary to affix some specific information to the container, just like as identifying by a human fingerprint or voice print, that is registered also in the surveillance center, and then by comparing the information affixed on the container with that registered in the center, it would be possible to detect the swapped, bogus container. To implement this, the specific information affixed to the container and its registration at the center should be handled automatically without human intervention, because people frequently leak specific information such as passwords.

Based upon the foregoing analysis, the following is an ideal means of addressing this problem.

The object, such as a cargo container, being monitored by the surveillance system according to this invention would be equipped with one or more communication devices functioning that would communicate with a plurality of communication nodes. According to this invention, it is possible to detect the “movement of communication nodes distribution” which is occurred by the movement of the object to be monitored, because the movement of the object will interfere with the communication nodes distribution. From the detected “communication nodes distribution”, therefore, it is possible to obtain the characteristic status information which can identify the object being monitored. This is a main feature of this invention.

The movement between the communication nodes, and the movement of the object will be explained as follows. In “movement”, there are two types involving the object being monitored in the following categories;

1) The deformation in the configuration of the object being monitored, and the displacement in a portion of the object (e.g. the opening or closing of the container door, somebody stepped into the container, or something was loaded into or out from the container, etc.).

2) The displacement of object being monitored (e.g. the displacement of the container from point A to point B).

According to this foregoing 1), the communication relay system mentioned above is used for a surveillance system for sensing the deformation of the object to be monitored, not for the communication purpose as the prior art U.S. Pat. No. 6,028,857. To wit, the object being monitored has nodes (communication nodes) that have communication functions (low-power transmitters), which are attached at various places in the space where the object to be monitored is located, such as side of a container. Each of these communication nodes communicates to generate the information of communication nodes distribution nodes, which is a characteristic of the spatial status of the nodes. This spatial status of the nodes, namely the information of communication nodes distribution, can represent the current status of the object to be monitored. For example, a certain communication node is selected as the central node, then the distance of the other nodes from that central node is determined by calculating the relaying times it takes for the communications from the nodes to arrive at the central node, and that information is reported to the central node. Thus, the specific information for the various nodes may able to represent their respective communication distances from the central node. Further, it is possible to determine communication node coordinates by knowing the number of communication nodes and measuring the communication distance from each of these communication nodes to base nodes, and to then determine the coordinates of the communications nodes by the intersection points of circles or spheres that use those measured distances as radii.

Yet another way would be to not establish a central node or any base nodes, but have each of the communication nodes detect their communication distance to respective other communication nodes (which could be done through a code expressing whether or not direct communication was possible, by establishing the number of communication nodes, which were required to communicate with another communication node, by computing based upon the transmission power requirements for the signal to achieve direct communication, or by computing the signal arrival time), and to assemble all of the detected distances to generate specific status information on the object. Thus, as far as the information of communication nodes distribution is specific to the object to be monitored, or if unique numbers are assigned to the communication nodes specific to the object, these can be specific status information that is required to identify the object.

One way to detect the distance from each node to other nodes mentioned above is disclosed in U.S. Pat. No. 6,028,857 of a communication network provided with a self-organizing network. This self-organizing network is a kind of a relay system to communicate between a plurality of nodes, each of which has a low-power transmitter for saving the battery power. This low-power transmitter can communicate only with the neighboring nodes which are located only a few meters away for the purpose of saving the battery power. The detail will be explained in the flow chart which will be explained later.

The foregoing 2) is the case where the position of the object being monitored changes. When a number of communication devices are attached on the object, and they communicate with other communication nodes provided on the object, the displacement is detected in the manner described below. To wit, in the case where a signal marker, GPS, beacon or other position measuring signal emitted from a signal generating station is used to communicate with a communication node, as the object being monitored moves, the relative position of the communication nodes to them will more accordingly. In this case, tracking signals are received from various communication nodes (e.g. GPS satellites), and data is obtained on where the object being monitored has been during each time frame. This time/space positioning data is unique to the object being monitored. The reason why it is unique to the object, is the law of physics that states that only one object can occupy the same space at the same time. However, considering the error that can result in the measurements of position and time, the detection of the object being monitored can be made much more reliable by using a series of time/space positions (the movement history of the object) rather than using a single time/space position of the object being monitored.

Accumulating the movement history of the object using the communication devices attached to the object, makes it possible not only to detect the movements of that object, but also to use for identifying the object as a specific status information.

### BRIEF DESCRIPTION OF THE DRAWINGS

FIG. 1 shows the system structure for the first embodiment for the surveillance system 1000 according to this invention.

FIG. 2(A) shows a network graph showing a link established between the communicating nodes before the door is opened.

FIG. 2(B) shows a network graph showing a link established between the communicating nodes after the door is opened.

FIG. 3(A) shows an initial network graph matrix corresponding to the network graph in FIG. 2(A).

FIG. 3(B) shows a network graph matrix corresponding to the network graph in FIG. 2(B), which is changed by opening the door.

FIG. 4 shows the overall processing flow to form the network graph matrix among the communication nodes in the communications network.

FIG. 5 shows a process flow in each communication node in the network of this surveillance system.

FIG. 6 shows a process flow in the control device showing how the control device communicates with other devices outside of the container in the surveillance system,

FIG. 7 shows the configuration of the cargo container in the surveillance system according to the second preferred embodiment of this invention. cargo container.

FIG. 8 shows the configuration of the history recording center device in the surveillance system according to the second preferred embodiment of this invention. cargo container.

### DETAILED DESCRIPTION OF THE INVENTION

The information of communication nodes distribution generated by the communication nodes installed upon the object being monitored can represent a movement of the object, and also it can be a status information to identify the object, if the communication nodes distribution is specific to that object, or the numerical data assigned to the specific object is specific. This principle is applied in the first embodiment of this invention.

By attaching a communication device to the object to be monitored, the movement history of object can be produced to detect the movement of that object and to provide specific status information that identifies that object. This principle is applied in the second embodiment of this invention.

As mentioned above, this invention can be applied to the security of the freight containers. The containers are conventional types having a structure which is standardized internationally, but this invention can be applied for any containers, and further it can be used for any mobile containers, and even house security applications.

The subject container is such that it may be loaded or unloaded interchangeably on conveyances such as freight trains, trucks, cargo ships, and aircraft, and it is equipped with fixtures that facilitate its raising or lowering by loading equipment. In addition to being strong enough to accommodate stacking, it is constructed to prevent slipping when stacked. Further, it may have a door or lid to accommodate lowering or stacking cargo into the container.

Definition

In this specification, the following definitions will be applied.

1) Communication Node:

Communication node is a node in a communication network. In the self-organizing wireless network which is applied in the following first preferred embodiment, the network comprises a plurality of communication nodes each of which communicates with other nodes. In the second preferred embodiment which uses the position history of time/space position, the GPS satellite is the communication node.

2) Communication Device:

A communication device is a device having a communication function and a memory function. This can be one of the communication nodes in the network. In the first preferred embodiment, the communication device can function as one of the nodes which form the self-organizing wireless network. In the second preferred embodiment, the GPS receiver is the communication device.

3) Information of Communication Nodes Distribution, or Distribution Information:

This is the information on how the nodes are located in a space. It can be defined by position coordinates, by the relaying times for communicating between the nodes to each other, also by the distance. It can also be defined by whether or not the communication carriers (radio wave, beam, sonic) can reach to the receiver. In the first preferred embodiment employing the self-organizing wireless network, it can be a HOPs table at each node. In the second preferred embodiment, it is a transmission time (since the transmission time is use for calculating the distance, it can be the distance between the container and the GPS satellite).

4) Status Information of Object

The status information of object is at least one of deformation, and position. In the first preferred embodiment, a network graph matrix is the status information of object. In the second preferred embodiment employing a history data of time/space position, a time/space position of a container is the status information of object.

First Preferred Embodiment

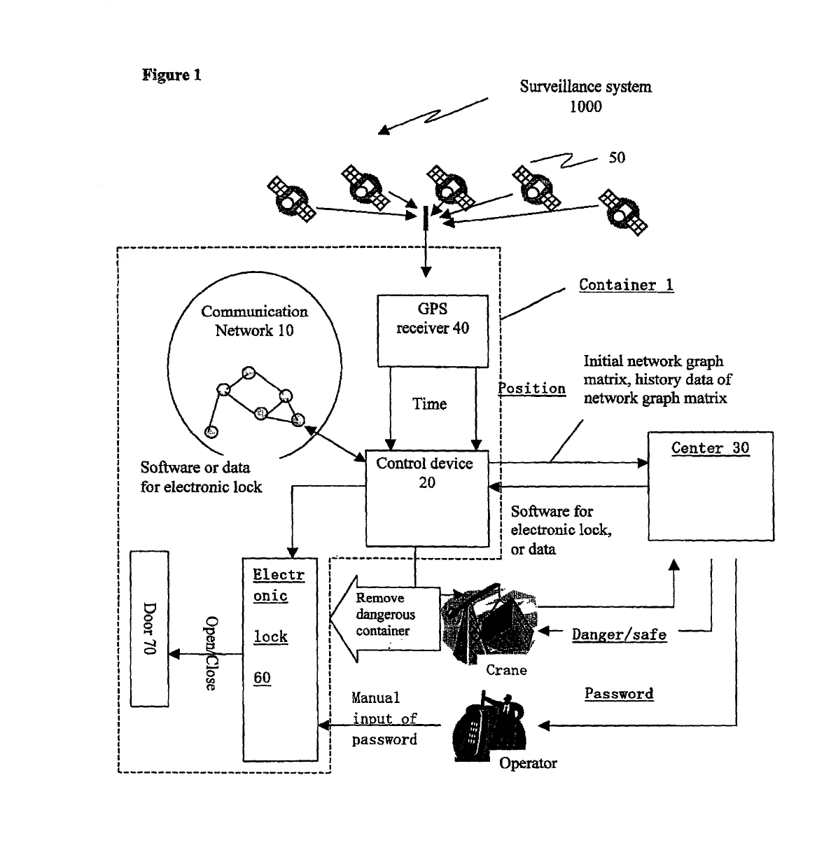

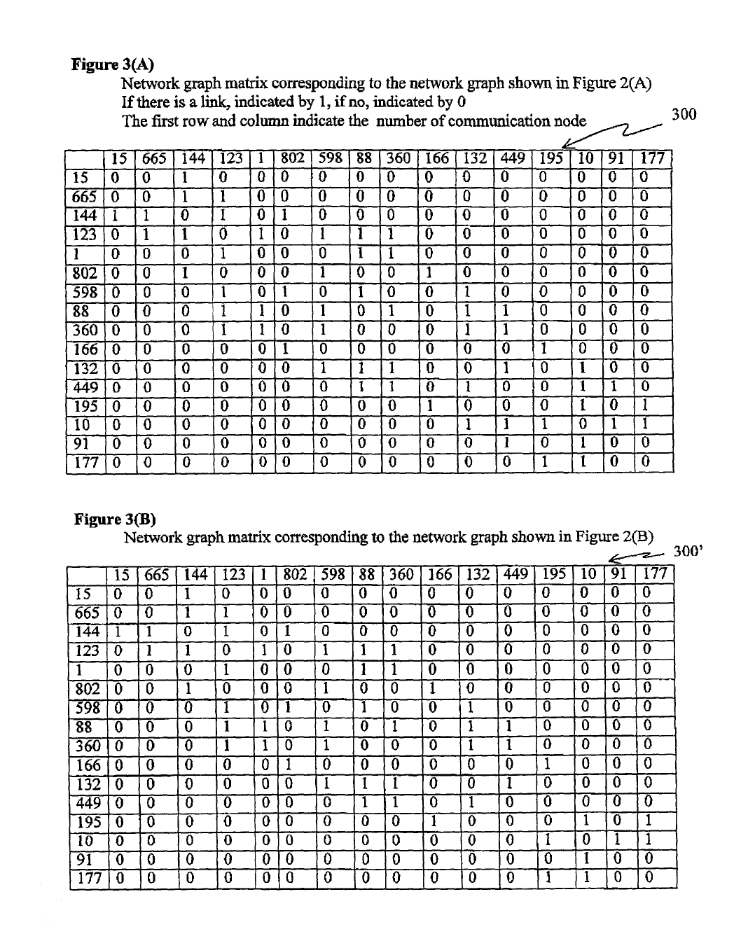

FIG. 1 shows the system structure for the first embodiment for the surveillance system 1000 according to this invention. The container 1 is equipped with a variety of electronic devices in a conventional container. A communications network 10, which will be described in detail below, has been established inside container 1. Communication nodes, which have wireless communications capabilities, have been attached inside of the container to the door, walls, and cargo to form the communications network 10. At a specified time interval, this communications network 10 generates a network graph matrix which expresses an information of communication nodes distribution in the communications network 10. This network graph matrix is unique for each such communications network. An example of the network graph matrix is shown in FIG. 3(A), FIG. 3(B) which will be explained in detail later.

The control device 20 for the container 1 is located inside of the container, and it functions as one of the communication nodes, which communicate wirelessly with the various communication nodes in the communications network. Upon receiving a specific command from the control device, all of the nodes in the communications network provided in the container to be monitored can auto-configure itself, and report the network graph matrix resulting from the auto-configuration to other communication nodes. In other words, all of the nodes will share the same information of the network graph matrix, which can make the system difficult to be altered illegally as will be mentioned later. When the control device 20 issues the command for the communications network 10 inside the container 1 to initialize, the communication network 10 inside of the container generates the initial network graph matrix, which is memorized by each communication node. Accordingly, the control device 20 also memorizes the initial network graph matrix. The control device 20 has wireless transceiver capabilities, and it is attached to a cable which extends to the outside of the container through a small hole in the container wall or gap in the door hinge, etc., to serve as its antenna. Outside of the container, this antenna cable communicates with an antenna of the wireless communication device provided at the center 30.

A GPS receiver 40 may be located inside or outside of the container 1, but the antenna for the GPS must be on the outside of the container. The GPS receiver 40 receives time signals from 4 sets or more GPS satellites 50 from which the distance between the container and the satellites can be determined. This, along with the accurate time, generates information on the position of the container, which is then sent to control device 20 as the conventional communication method. When the loading of the container has been completed, the control device commands the communications network 10 to generate the initial network graph matrix 300. The example is shown in FIG. 3(A). Upon receiving this network graph matrix, the control device 20 takes this as the initial network graph matrix, and wirelessly reports it along with the time and position information from the GPS receiver 40 and the container control number to the center 30. The center 30, records this information in memory as the characteristic information for that container which will be used to identify the status of the container 1.

Next, the verification processing that takes place when the container 1 reaches its destination will be described. When the container reaches its destination, it is first grasped, suspended and moved to the container yard by a crane according to the conventional freight transportation system. Prior to the container being moved by the crane or during it is moving, the following information is read out from the control device 20 of the container 1.

1) Initial network graph matrix 300, location and time information at the time of the notification as well as the container's control number,

2) History data of the network graph matrix (in cases where the GPS receiver was available during the transportation, the time and position data is added with each change in the network graph matrix).

The crane, which has the capability of reading and acquiring the foregoing data 1) and 2) or has the intelligence function of receiving such data from the center 30, could make the determination that this is a dangerous container prior to lifting it if it is unable to read out the data because of an alternation of the system which might have been done illegally by somebody having no authority. If it succeeds in reading out the data, it then transmits that data to the center if it is not yet reported to the center. At the center 30, that data is compared with the previously registered data which was acquired at the time the container shipped out. In the case where there is no match as a result of the comparison of the network graph matrix acquired at the time the container arrived at the container yard, plus any data on position and time appended during the registration of the initial network graph matrix, with the information that was recorded to the center, the center makes the decision that it is a dangerous container and notifies the crane for special attention.

Further, if, as a result of the comparison of the initial network graph matrix with the acquired history data of the network graph matrix, for example, the history data of the communication nodes attached to the container door 70 had deviated substantially from the initial network graph matrix more than a predetermined value, then the center makes the determination that it is a dangerous container due to the improper opening/closing of the door 70. In such a case, the center 30 would notify the crane that the container is dangerous. The crane can then deal with any containers that have been determined to be dangerous, such as by moving them to a special area. In the center, it is necessary to know which links of the nodes are related to the open/close of the door from the network graph matrix. In order to know this, each of the communication nodes at the door are arranged relatively closer, and the nodes at the counter wall of the container are arranged relatively far from the nodes at the door and separately each other. With this arrangement, the relaying transaction between the nodes at the door is more frequently done than other nodes. Since the center can easily detect such frequent relaying data by analyzing the network graph matrix, it is possible to identify the specific nodes which are related to the fact if the door was illegally opened.

Of course the comparison of the network graph can address for any portion in the container, it will be able to detect any deviation of the status in the container, such as deviation caused by the missing cargo or, on the contrary, adding the cargo, especially dangerous cargo.

When the container 1 is moved in the container yard, and the door of the container needs to be opened, since the container 1 according to this invention is equipped with an electronic lock 60, the door cannot be opened without a password. The password for this container 1 is automatically generated at the center 30 based on the initial network graph matrix, the time and the position at the time of the notification, and the container's control number. The center 30 then downloads the electronic lock software or data to the electronic lock via the control device. This download should best take place only after the container has arrived at its destination and its safety is confirmed. After the download has taken place, the center 30 then can wirelessly notify the person having authority the password to open the container door (the consignee, custom officers, etc.) by cellular phone or other separate safety route. Since the password was generated based on the configuration of the initial network graph matrix, the downloaded software does not open the door unless the received password is corresponding to the initial network graph matrix. Only when such condition is satisfied, the person who receives this password notification can then open the container door. Thus the center 30 is able to control who is able to open the container door by the foregoing means.

Next, the communications network 10 installed inside of the container will be described. A plurality of nodes (communication nodes) having communication capabilities are disbursed and attached to the inside of the container's wall and door. It is also possible to attach them inside of the loaded cargo. These communication nodes communicate with each other to generate the position information by communicating with each other between the nodes, and they will be self-organizing the communication network 10. An example of such a self-organizing network is disclosed in U.S. Pat. No. 6,028,857.

According to this invention, each communication node has at least the capabilities set forth in 1 through 4 below.

1. ID memory capability

2. Wireless communication capability to communicate with the neighboring communication nodes

3. Self-contained battery power supply

4. The capability to memorize the HOP number table, which relates to all of the communication nodes in the container and the number of communication HOPs it takes to communicate with each node via the neighboring communication nodes.

As an option, if the communication nodes have below-listed capability 5, the communications network also becomes a sensor network.

5. A sensing capability for the local status around the communication nodes (e.g. acceleration, vibration, temperature, the concentration of a specific gas, etc.)

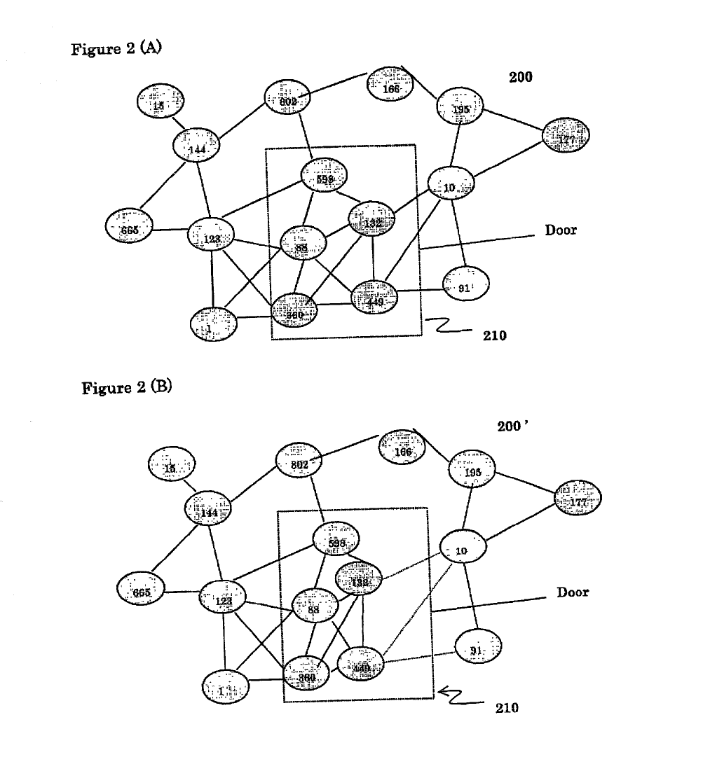

In order to conserve electric power, and express the relative spatial distribution of the nodes in the space where the object to be monitored is located, the communication nodes are set to communicate with each other with a weak signal, which enables them to communicate among themselves over communication links. This weak signal can be made with radio wave, acoustic wave, light beam. As a result, this means that each communication node can only communicate with adjacent or neighboring nodes. Communications with distant nodes take place by relaying through the intermediate nodes. To wit, each communication node functions only if the electric field strength of the message from the other communication node is above a certain level. When the electric field strength of a message from another communication node is above the predetermined level, a link is established between the communicating node and the receiving node. This establishment of links between communication nodes is shown in form in FIG. 2(A). This is called a network graph 200. In this graph, if the nodes are linked with a single line, it means they are within the distance, or the status to communicate directly. If there is a link between node p and node s, the value of 1 is set, and if not, the value of 0 is set. When such value setting is done between all of the nodes shown in the network graph, the initial network graph matrix 300 is formed as shown in FIG. 3(A). In FIG. 3(A) and FIG. 3(B), row 1, column 1 represents the ID numbers of all of the communication nodes shown in the network graph 200 shown in FIG. 2(A). From this initial network graph matrix 300, it can be understood that, for example, there is a link between node 144 and 802, but no link between node 144 and node 598, because each of the nodes are communicating with each other only with a weak signal which reaches the neighboring nodes.

Next, the method for detecting container abnormalities or status changes by using the communications network 10 installed inside of the container 1 will be described. FIG. 2(A), for example, shows the links established among the large number of communication nodes inside the container. The group of communication nodes 210 enclosed by the broken line are those installed on the door 70 {598, 88, 132, 360, 449}. These numbers represent the ID number of each node. When the container door is opened or closed, the link status with the other adjacent communication nodes {10, 91} will change because of the movement of the door, and the links between these nodes are disconnected.

For example, in the case of an out-swinging door with its supporting hinge located in the area of the communication nodes 88 and 360, communications will cease over the following link groups when the door is opened and the distance increases between communication nodes resulting in the network graph 200′ as shown in FIG. 2(B).

Link (132,10)

Link (449,10)

Link (449,91)

Also, if the door were a sliding door, conversely, new links also would be formed as the distance of the communication nodes near the sliding door may became closer.

The surveillance system according to this invention is not confined to just the opening and closing of the container door. A person who wanted to introduce dangerous material into a container could, for example, avoid the closed door and use the ventilation openings or remove a side plate from the container to insert the material within. In such cases as well, there would be a change in the link relationship among the communication nodes. The deformation in the link relationship will show up as the deformation of the network graph matrix 300′ as shown in FIG. 3(B) where the indications of “1” are changed into “0” between nodes 132 and 10, 449 and 10, and 449 and 91.

Any difference in the current network graph matrix from the previous network graph matrix that was generated at the time when the door of the container was closed following the loading of the cargo, indicates the possibility of a container abnormality.

Next, the way of using the communications network inside the container to establish that the container is the same as the original, will be explained.

Detecting that no substitution of a bogus container has taken place, is very important for identifying the original container, and for using the electronic lock for the opening and closing of the container door. Conventionally, a container password simply corresponding to the container's serial number is devised by humans. However, the biggest problem with this method in the past is that the password and the container serial number were simply unrelated data to the unique properties of the container. Accordingly, it was possible to substitute by switching the ID and the corresponding correct password of another container.

In order to protect such illegal handling of the container, the network graph can be a detection tool to detect such illegal handling because the network graph or network graph matrix indicates unique properties of the container, it is generated automatically without human intervention. If a person deliberately tried to alter the network graph matrix, the action would be detected easily by comparing with the original data.

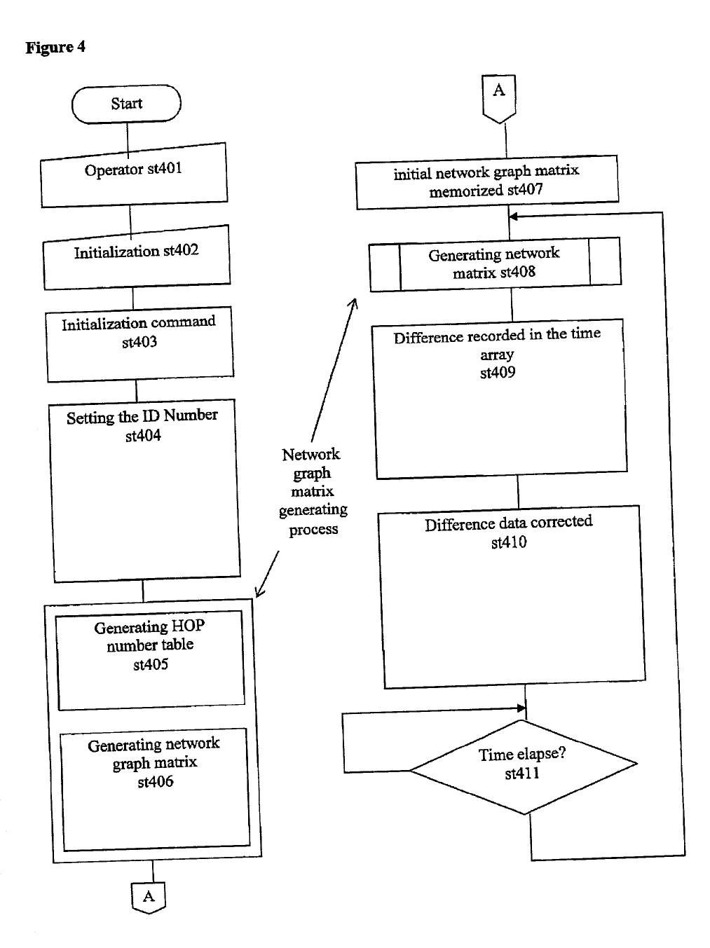

FIG. 4 shows the overall processing flow to form the network graph matrix among the communication nodes in the communications network which is a part of the surveillance system 1000 according to this invention. The flow chart in FIG. 4 is addressing how the user of this surveillance system can initialize the system.

In st401, an operator installs communication nodes inside the container 1. These communication nodes are small devices provided with a transmitter for weak signals and the receiver for receiving such weak signals from the neighboring nodes. Then, in st402 the operator gives the initialization command for the control device 20. This control device can be one of the nodes, or an independent dedicated device. In st403, the control device 20 issues the initialization command to all communication nodes. Since the nodes are not yet assigned the node numbers, the control device sent the initialization command with relatively big power to all of the nodes so that they can initialize all at once. In st404, each communication node sets its own ID number using a randomly generated number (the number of digits for the random number should be sufficient to allow ignoring the probability for duplicate numbers). This is because the randomly generated ID number can not be detected by humans, especially by strangers, and it enhances the security level of the container.

St405 and st406 are the steps for generating the network graph matrix. In st405, the communications nodes communicate among themselves with the other nodes and memorize a HOP number table which defines the distance to other nodes.

One way to detect the distance from each node to other nodes mentioned above is disclosed in U.S. Pat. No. 6,028,857 of a communication network provided with a self-organizing network. This self-organizing network is a kind of a relay system to communicate between a plurality of nodes, each of which has a low-power transmitter for saving the battery power. This low-power transmitter can communicate only with the neighboring nodes which are located only a few meters away for the purpose of saving the battery power. The detail will be explained in the flow chart which will be explained later. When node 1 wishes to communicate with node x which is located out of the communication range of the low-power transmitter, node 1 can send it's message to the neighboring nodes with a message of “forward my message to node x if you can do so within fewer than 4 HOPs”. Here, the “HOP” is defined as a relaying number (times) to relay the message before the message finally reaches the destination node. If the neighboring nodes which received the message from node 1 are the ones who know they can forward the message to node X within the requested HOP number (number of relay), they will forward or relay the message again to the neighboring nodes after they subtract 1 from the received HOP number. This relaying process will be continued until the message reaches to node x. In this relay system, each node has a table which indicates the relaying number (HOP number) to send the message to each of the other nodes. For example, for sending a message from node 1 to node 2 requires HOP 3, to node 3 HOP 5, to node 4 HOP 2 etc. In other words, the HOP number table is defined by HOPs which are the relaying times between each of the nodes. This HOP number table will stay unchanged according to the above patent unless it is renewed by a so-called flood message.

We added the following functions to the above prior art technology. After the HOP number table is created in st405, each communication node collects all of the HOP number tables from other nodes to create the network graph matrix in st406. In other words, all communication nodes will obtain the same network graph matrix, and this arrangement will enhance the security level, because it is more difficult to alter the graph matrix memorized illegally in each node.

In st407, the initial network graph matrix is memorized by each of the communications nodes. This initial network graph matrix is a base data to be compared with the matrix data obtained at a later time. In st408, the surveillance system according to this invention will generate the network graph matrix at a predetermined interval so that the surveillance system can periodically monitor the status of the object to be monitored, such as the inside of the container. This st408 is a same step as st405 and st406 mentioned above. In st409, each communications node detects differences between the initial network graph matrix of st407 and the generated network graph matrix of st408. If there is a difference between the initial and the generated matrix, the difference is recorded in the time array by each communications node. Then in st410, each communications node collects the difference data detected by the other communications nodes, and if it is determined to be a mistake in terms of its own majority logic, an error message is generated with its own node ID attached, which is transmitted to the other communications nodes and the node's own difference data record is corrected with the correct data difference. This step will be taken in order not only to ensure the data of the error messages, but also protect the memory function to memory the history data by holding same data by each of all nodes. Above steps are repeated periodically as checked in st411.

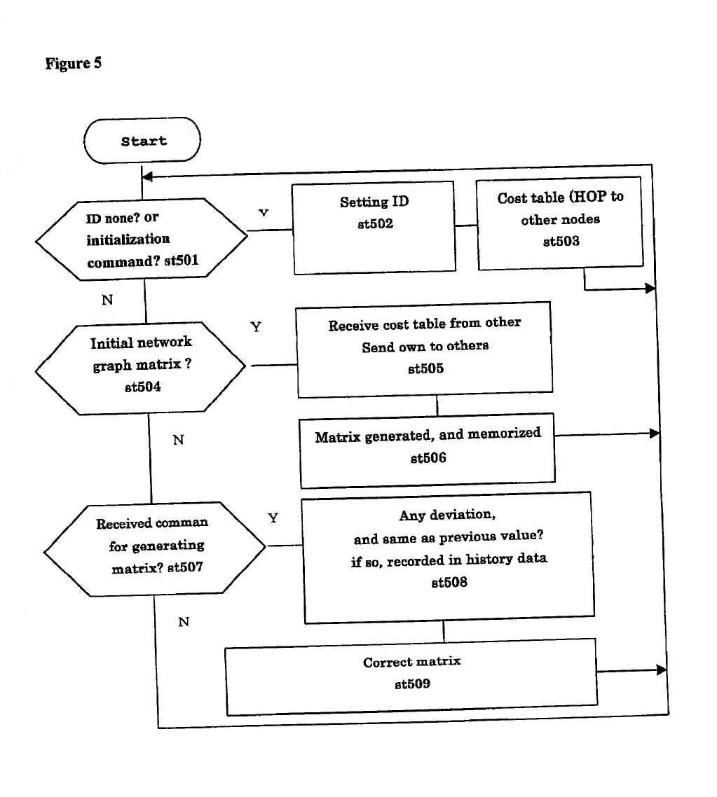

FIG. 5 is a process flow in each communication node in network 10 of this surveillance system 1000. In st501, if the node has no ID or if the node received the initialization request from control device 20, then in st502, the node will generate the ID by random number which has sufficient digits to allow ignoring the probability for duplicate numbers. In st503, the so-called “cost table” which indicates the Hop number to other nodes from the node is generated. The method to obtain such cost-table is disclosed in U.S. Pat. No. 6,028,857 in details. The basic concept of this patent is to use a so-called flooding message in order to detect the message relaying time to all of nodes from each node. With this flooding message, each node will know the minimum relaying times to transmit it's own message to all of the nodes by using a relatively weak signal which can transmit the message only to the neighboring nodes, but can save the battery energy of the transmitter.

If No at st501, then it is checked at st504 if the initialization request from the control device 20 is received. If Yes, then at st505 each node receives each “cost table” from each node, and also each node sends it's own “cost table” to all of the other nodes, so that, at st506, all other nodes can establish the same network graph matrix at each node location. Since this step is taken at the time of initiation of the system after the container has completely been loaded with the cargo, the network graph matrix 300 generated at this step is memorized as an initial network graph matrix which will be the reference matrix to be compared with the matrix generated at the time of interval detection.

After the initiation of the system mentioned above, the surveillance system will start to detect the status of the container by establishing the network graph matrix. If such a request is received by each node in the system at st507, the current network graph matrix established at st508 is compared with the initial network graph matrix established at st506. If there is any deviation from the initial in the current network graph matrix, the node or the control device 20 will record the deviation each time it detects such an event. In order to avoid the miss-detection of a deviation at each node, at st509 each node can compare the matrix data which is owned by the neighboring nodes, and corrected according to the majority logic.

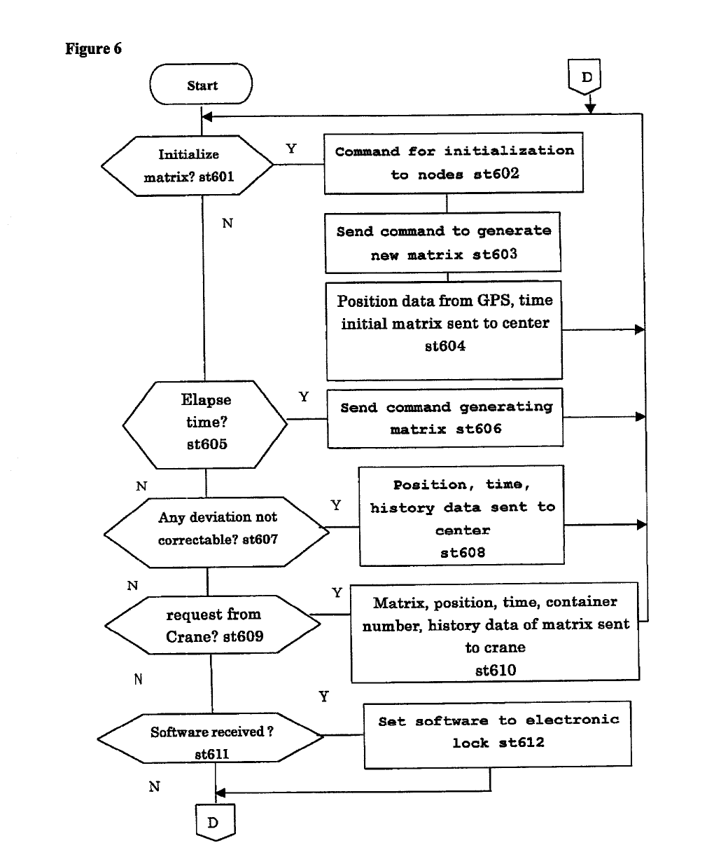

FIG. 6 is a process flow in control device 20 showing how the control device communicates with other devices outside of the container in the surveillance system 1000 according to this invention. At st601, when the control device 20, receives a message to initialize the network graph matrix in the surveillance system 1000, at st602 the control device 20 will send a command to the communication nodes to do so. The control device 20 then sends the command to the nodes to generate the new initial network graph matrix at st603, and obtains it from the nodes and sends it to the control center 30 along with the position data transmitted from GPS receiver 40 and the time data at st604.

At st601, if the control device 20 did not receive the message to initialize the initial network graph matrix 300 at st601, and if the predetermined interval time has elapsed at st605, then the control device 20 sends the command to nodes to generate the current network graph matrix at st606. These steps will be repeated periodically for surveilling the inside of container 1.

At st607, the deviation between the previous and current network graph matrix, which can not be corrected by the majority logic, the control device will detect whether or not any real changes, such as the fact that the door was opened, or somebody entered the container, etc., have occurred. This fact is recorded as a history data and sent to the control center 30 along with the position of the container obtained from GPS receiver 40 and the time data at st608. This step will be repeated each time such status occurred in container 1 so that this surveillance system can monitor the container any time until arrival at the destination.

At st609, for example, when container 1 arrives at the destination harbor, and is ready to be lifted up by the crane at the container yard, the crane requests the control device to transmit the history data to control center 30 in order to confirm if there was a deviation of the container status during the traveling time between the shipping out location and the destination at st609 and st610. If control center 30 confirms that there was no deviation of the container status, and the security of the container is confirmed, then control center 30 will send the software for opening the electronic lock system 60 to the control device 20 at st611, and the software will be installed in the electronic lock system 60 by control device 20 at st612. The consignee or custom officers will receive the password from control center 30 through the separate safety route which is guaranteed for security, and the container is now ready to be opened after the security is guaranteed. The separate safety route is, for example, E-mail, or other separate communication route from this system.

Second Preferred Embodiment

The second preferred embodiment of this invention is a surveillance system based on the history data of time/space positioning data, because the data is unique and characteristic to the object being monitored according to the law of physics. The low states that only one object can occupy the same space at the same time.

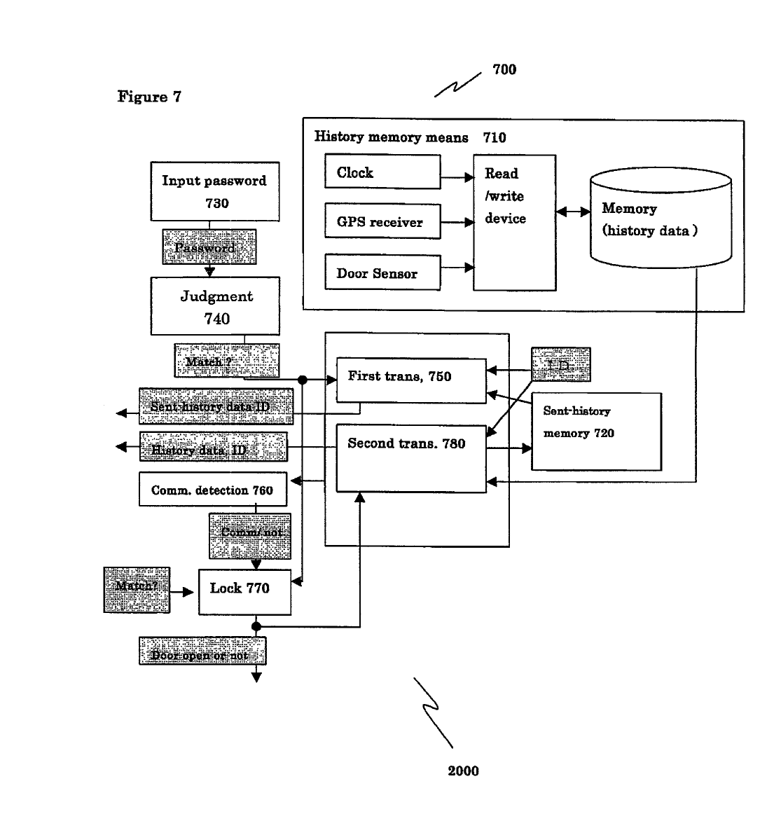

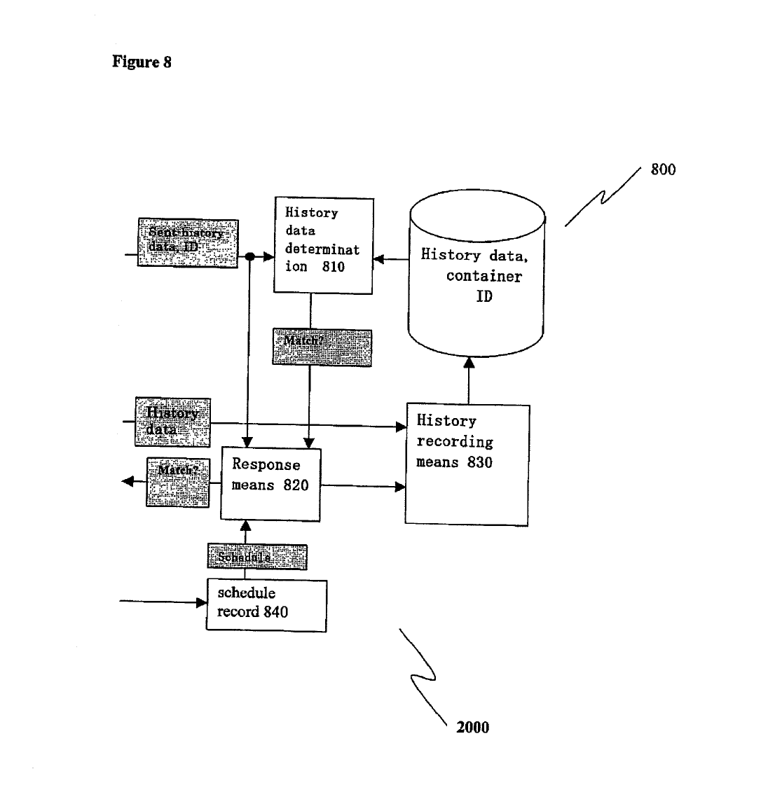

The surveillance system 2000 of this second preferred embodiment comprises the following functions at the container side, and the surveilling center side respectively. Each function is referred to in FIG. 7 and FIG. 8.

1) Cargo Container

The cargo container is equipped with a local surveillance device 700 which has the following a) through h) functions.

a) A history memory means 710, which memorizes the movement of the container, such as (1) the time information when the door is opened or closed, and (2) the movement of the container (a list of the time and location of the container) which has the ability to detect the time when the freight container door is opened or closed, irrespective of whether or not it can be opened and closed by an electronic lock means, and to detect the displacement of the container. For the displacement of the container, the GPS receiver 40 will be used. The GPS receiver receives time signals from 4 sets or more GPS satellites 50 from which the distance between the container and the satellites can be determined. When the container moves, the displacement of the container will be detected by this arrangement.

b) A sent-history memory means 720, which records the data of the history already sent to the history recording center device 800, shown in FIG. 8, which is provided at the control center 30.

c) A password input means 730 to receive a password

d) A password determination means 740, which determines whether or not the password that was input via the foregoing password input means is the correct password that matches the one for that freight container

e) A first transmission means 750, which only in the case where the password is determined to be correct by the foregoing password determination means 740, transmits to the foregoing history recording center device 800, the foregoing history data recorded in the sent-history memory means 720 or the processed history data processed by the predetermined processing method, along with the ID of the container

f) A communications detection means 760, which detects that communications are underway with the foregoing history recording center device 800

g) An electronic lock means 770, which permits the opening or closing of the freight container door only in the case when the password determination means 740 determines that the password matches, when the communications detection means 760 detects that communications are underway, and when in response to the transmission of history data by the first transmission means 750, the history recording center device 800 responds that the data matches the historical data

h) A second transmission means 780, which transmits the history data stored in the history memory means 710 along with the ID of the container to the foregoing history recording center device, only when the electric lock means 770 permits the opening/closing of the freight container door

2) A History Recording Center Device 800 Equipped with the following, a) through d):

a) A history data determination means 810, which determines whether or not there is a match between the received history data along with the ID of the container and the previous history data that was recorded along with the ID of the container

b) A response means 820, which responds to the freight container that there is a match when there is a determination of a match by the foregoing history data determination means 810 and when there is a match within the designated range of the received history data and the predicted schedule

c) A history recording means 830, which, following the response of a match from the foregoing response means 820, records the history data along with the ID of the container that was transmitted as appropriate information, so that the history data can be used for the correct history data at a later time

d) A prediction recording means 840, which, prior to the doors being closed and the subject container being transported, records the predicted schedule of the traveling schedule including any open and closing schedule, which is transmitted by the person authorized by the password

The following is an over all flow how the container with the local surveillance device 700 is protected from the illegal operation. First, should the password that is input into the password input means on the container be incorrect, there being no output of a match from the password determination means, the opening or closing of the door would not be permitted by the electronic lock. Should the prohibition by the electronic lock be broken and the door forcibly opened or closed, since the appropriate data regarding the historic data for the opening/closing history of the door would not be transmitted to the history recording center device, the data recorded by the freight container itself would not match its own history data. In that event, the next time that there was a history data transaction between the freight container and the history recording center, a mismatch in the data would appear and permission to open/close the electronic lock would not be granted. If permission is not granted for the opening/closing of the electronic lock, the history data, that is the correct history data for the freight container, is not transmitted. This results in there being a greater mismatch between the history recorded in the history recording center device for that container, and the history recorded by the container itself. Since freight containers having this kind of history data mismatch are not normal, they are detected as dangerous containers and thereby easily controlled.

In cases where conditions are such that the freight container is unable to communicate with the history recording center device, no permission will be granted for the electronic lock to enable the opening/closing of the door, even if the correct password is supplied. Should there exist an environment where the communication with the history recording center device is cut off, the possibility exists for tampering with the freight container. For example, the door could be forcibly opened without permission by the electronic lock for opening/closing. In that case, a mismatch would develop between the history data recorded by the freight container and that recorded by the history recording center device. As a result, that freight container would be detected as a dangerous container and thereby easily controlled.

In cases where the container password is leaked, and an unauthorized person uses it to open or close the door, a mismatch develops between the predicted history and the recorded history that exceeds the specified standards. This causes the freight container to not receive the match notification from the history recording center device. This in turn causes no permission to be granted for the opening/closing of the electronic lock. Since there is no permission for the electronic lock, if the door is opened or closed a glaring mismatch occurs between the history recorded by the history recording center device and the history maintained by the freight container, which allows the container to be detected as a dangerous container.

If a bogus container was substituted for the original, the displacement history and the history of the door opening and closing would differ between the bogus and real container, making it easy to detect the container as dangerous.

According to the invention mentioned above, rather than designing a conventional sensor appropriately to detect dangerous materials according to the properties of such dangerous materials, the method for detecting the “movement” which would occur during the act of secretly hiding dangerous materials in the container would be a universal detection method for detecting abnormalities that is unaffected by the nature of the dangerous material being detected. This invention can be applied for the varieties of industrial field, such as a safety container field.

What is claimed is:

1. A status detection system to detect an object status, comprising:
one or more communication devices, each of which has a wireless communication capability to communicate with a plurality of communication nodes;
an information collecting means to collect an information of communication nodes distribution, which was received by said communication device; and
a status information generating means to generate a status information of said object from said collected information of communication nodes distribution.

2. A surveillance system to survey an object status, comprising:
one or more communication devices, each of which has a wireless communication capability to communicate with a plurality of communication nodes;
an information collecting means to collect an information of communication nodes distribution, which was received by said communication device;
a status information generating means to generate a status information of said object from said collected information of communication nodes distribution;
an initial status recording means to record said status information generated by said status information generating means as an initial status information; and
a comparison means to compare a current status information generated by said status information generating means with said initial status information obtained from said initial status recording means, and output the comparison result.

3. An identification system to identify an object status, comprising:
one or more communication devices, each of which has a wireless communication capability to communicate with a plurality of communication nodes;
an information collecting means to collect an information of communication nodes distribution, which was received by said communication device;
a status information generating means to generate a status information of said object from said collected information of communication nodes distribution;
a registration means to send and register said status information generated by said status information generating means in a remote center, said status information being registered as a characteristic information which represents said object status;
a status recording means provided in the object to record said characteristic information; and
a comparison means to compare said characteristic information registered in said remote center with said characteristic information recorded in said status recording means, and output the comparison result.

4. A communication network system having a plurality of communication nodes which comprise a plurality of wireless communication devices installed in an object to be surveyed, each communication node generating a cost data for conveying a message to the other nodes by communicating with the neighboring nodes provided in said communication network system by means of the self-organizing, wherein at least one of said plurality of communication devices, comprising:
a cost data collecting means to collect said cost data for conveying a message provided in each communication node; and
a status generation means to generate a status information of said object to be surveyed by said cost data of each communication node collected by said cost data collecting means, said status information representing the entire relationship between said plurality of communication nodes provided in said communication network system.

5. A surveillance system to survey an object, provided in a communication network system having a plurality of communication nodes which comprise a plurality of wireless communication devices installed in the object, each communication node generating a cost data for conveying a message to the other nodes by communicating with the neighboring nodes provided in said communication network system-by means of the self-organizing, wherein at least one of said plurality of communication devices, comprising:
a cost data collecting means to collect said cost data for conveying a message provided in each communication node;
a status information generation means to generate a status information of said object to be surveyed by said cost data of each communication node collected by said cost data collecting means, said status information representing the entire relationship between said plurality of communication nodes provided in said communication network system;
a status recording means provided in the object to record said status information generated by said status generation means as an initial status information at predetermined timing; and
a comparison means to compare a current status information generated said status generation means with said initial status information output from said status recording means.

6. An identification system to identify an object provided in a communication network system having a plurality of communication nodes which comprise a plurality of wireless communication devices installed in the object, each communication node generating a cost data for conveying a message to the other nodes by communicating with the neighboring nodes provided in said communication network system by means of the self-organizing, wherein at least one of said plurality of communication devices, comprising:
a cost data collecting means to collect said cost data for conveying a message provided in each communication node;
a status information generation means to generate a status information of said object to be surveyed by said cost data of each communication node collected by said cost data collecting means, said status information representing the entire relationship between said plurality of communication nodes provided in said communication network system;
a registration means to send and register said status information generated at predetermined timing by said status information generating means in a remote center, said status information being registered as a characteristic information which represents said object status; and
a comparison means to compare said characteristic information recorded in said status recording means with said characteristic information registered in said remote center, and output the comparison result.

7. A surveillance system to survey an object, provided in a communication network system having a plurality of communication nodes which comprise a plurality of wireless communication devices installed in the object, each communication node generating a cost data for conveying a message to the other nodes by communicating with the neighboring nodes provided in said communication network system by means of the self-organizing, wherein all of said plurality of communication devices, comprising:
a cost data collecting means to collect said cost data for conveying a message provided in each communication node;
a status information generation means to generate a status information of said object to be surveyed by said cost data of each communication node collected by said cost data collecting means, said status information representing the entire relationship between said plurality of communication nodes provided in said communication network system; and
an abnormal detection means to detect an abnormality by comparing own status information of said object to be surveyed and said status information owned by other communication nodes, and if the abnormality detected, process a predetermined abnormal processing.

8. A status detection system to detect an object status, comprising:
a communication device which is provided on the object and has a wireless communication capability to communicate with a plurality of communication nodes;
a position data collecting means to collect a position data of each communication node detected from said communication device; and
a time/space position recording means to generate a time/space position data of the object, which consists of time and position, by said position data of each communication node obtained from said position data collecting means, and record said time/space position data in time array.
